(19) United States
(12) Patent Application Publication
(10) Pub. No.: US 2023/0064532 A1
(43) Pub. Date: Mar. 2, 2023

(54) AIR PURIFIER

(71) Applicant: LG ELECTRONICS INC., Seoul (KR)

(72) Inventors: Minha LEE, Seoul (KR); Seungho BAEK, Seoul (KR); Heejae KWON, Seoul (KR); Soonho JUNG, Seoul (KR)

(21) Appl. No.: 17/799,969

(22) PCT Filed: Jan. 20, 2021
(86) PCT No.: PCT/KR2021/095011

§ 371 Date: Aug. 16, 2022

(30) Foreign Application Priority Data
Feb. 19, 2020 (KR) 10-2020-0020266

(51) Int. Cl. F24F 1/0047; F24F 1/0014; F24F 1/0071; F24F 11/79

(52) U.S. Cl. CPC F24F 1/0047; F24F 1/0014; F24F 1/0071; F24F 11/79; F24F 2110/50

(57) ABSTRACT

An air purifier includes: a case in which an inlet is formed at a lower portion thereof and a discharge port opened in a horizontal direction is formed at an upper portion thereof; a purifying unit accommodated inside the case; and air-blowing unit for sucking air into the inlet and allowing the air to pass through the purifying unit, and then blowing the air to the discharge port; an air current control body in which an opening portion that is less in size than the discharge port and opened in the horizontal direction is formed; a lifting instrument for lifting the air current control body; and a rotation instrument for rotating the air current control body.

### TECHNICAL FIELD

The present disclosure relates to an air purifier, and more particularly, to an air purifier from which air purified by a purification unit is discharged.

### BACKGROUND ART

An air purifier is a device that is provided in homes, offices, and public offices to purify indoor air.

The air purifier may include a blowing unit for flowing air, and a purification unit such as a filter.

The air purifier may be classified into a ceiling-type air purifier that is mounted on a ceiling or connected to a wire extending downward from the ceiling, a wall-type air purifier that is mounted on a wall, and a standing-up-type air purifier used indoors on the floor, depending on the installation location thereof.

In one example of the ceiling-type air purifier, a lower suction port through which air is sucked may be formed in a lower surface, an upper discharge port through which air is discharged may be formed in an upper surface, and a blowing unit and a purification unit may be disposed therein. In addition, indoor air may be sucked into the air purifier through the lower suction port and purified by the purification unit, and the air purified by the purification unit may be discharged to the upper side of the air purifier through the upper discharge port.

Among air purifiers, an air purifier having a flow path structure of lower suction/upper discharge may gradually accumulate foreign substances such as dust (hereinafter referred to as dust) around the air purifier on the upper surface of the air purifier while operation thereof is stopped, and move the dust accumulated on the upper surface of the air purifier by the air blown upward from the air purifier to scatter the dust around the air purifier when operation of the air purifier is resumed.

On the other hand, the air purifier may suck air to the lower surface to purify it, and discharge the purified air in the side direction instead of the upper direction. An example of such an air purifier is disclosed in Korean Patent registration No. 10-1176565 (published on Aug. 23, 2012).

In the air purifier disclosed in Republic of Korea Patent Registration No. 10-1176565 (published on Aug. 23, 2012), outlets are formed in the side plates of upper and lower frames, and the air purified in the purification unit may be discharged in the side direction of the upper and lower frames through the outlets.

### Invention

### Technical Problem

In a conventional air purifier, since the air purified in the purification unit is discharged in four directions such as the front, back, left and right direction of the upper and lower frames through the outlets, it is not easy to discharge the purified air in a specific direction, and it may take a long time to purify a specific area with a high degree of pollution in a room.

An object of the present disclosure is to provide an air purifier capable of forming a concentrated airflow in a specific direction with a simple structure.

### Technical Solution

An air purifier according to an embodiment of the present disclosure may include an airflow control body having a size smaller than an open area of a discharge port through which air is discharged, and a rotating mechanism for rotating the airflow control body.

The air purifier may include a case in which a suction port and a discharge port are formed. The air purifier may include a top cover and a housing having an upper end spaced apart from the top cover and having a space formed therein. The top cover and the housing may constitute the case.

The air purifier may include a purification unit accommodated in the space, a suction body disposed below the housing, and a discharge body disposed under the top cover.

The air purifier may include a flow path body disposed below the discharge body, and a blowing unit that sucks air into the suction body, passes through the purification unit and the flow path body and blows the air to the discharge body.

The suction port may be formed in a lower portion of the case. The suction port may be formed to be opened in a vertical direction in the lower portion of the case. The suction port may be formed in the suction body.

The discharge port may be formed in an upper portion of the case. The discharge port may be formed to be opened in a horizontal direction in the upper portion of the case. The discharge port may be formed to be opened between the top cover and the housing, and may be opened in the horizontal direction. The cross-sectional shape of the discharge port may be a ring shape.

The air purifier may further include a thermal sensor disposed on the lower portion of the housing or the suction body.

The discharge body may have a blower accommodation space formed therein.

The blowing unit may include a blower formed in the blower accommodation space, and a motor connected to the blower. The motor may be installed on the top cover. A motor housing part surrounding the outer periphery of the motor may be formed in the top cover.

The air purifier may further include a hanger unit installed on the ceiling, and the hanger unit

may have a wire connected to at least one of the top cover or the housing.

The flow path body may include a hollow body and an inner body.

The hollow body may be disposed on the purification unit, and a passage through which air passes may be formed in the hollow body.

The inner body may be disposed on the hollow body, and the inner body may block between an upper portion of the hollow body and an upper portion of the housing.

The size of the airflow control body may be smaller than the open area of the opened discharge port. An opening opened in a horizontal direction may be formed in the airflow control body.

The airflow control body may include an air guide. The air guide may be spaced apart between one end and the other end in a circumferential direction. The cross-sectional shape of the air guide may be an arc shape.

In the airflow control body, a hollow portion opened in the vertical direction may be formed.

The airflow control body may further include a lower body. The lower body is connected to the lower portion of the air guide and may be rotated by a rotating mechanism.

The rotating mechanism may include a driven gear formed in the lower portion of the airflow control body, a driving gear engaged with the driven gear, and a rotating motor for rotating the driving gear.

The air purifier may further include a lifting mechanism for raising or lowering the air flow control body.

The lifting mechanism may raise the airflow control body to the discharge port or lower the airflow control body into the housing.

The air purifier may include a sensor for sensing an indoor pollution level and a controller.

When the pollution level sensed by the sensor is within a set range, the controller may control the rotating mechanism in a concentrated discharge mode in which the opening faces an area where the sensor is located.

### Effect of the Invention

According to an embodiment of the present disclosure, the airflow control body having a smaller size than the discharge port may guide the air blown from the blowing unit to be discharged intensively, and the airflow control body may be rotated to change the direction in which the air is discharged intensively. It is possible to control the concentrated discharge direction of air with a simple configuration.

In addition, when the airflow regulating body rises to the discharge port, air may be guided to the airflow control body to be discharged while forming a concentrated airflow, and, when the airflow control body is lowered into the housing, air may be discharged while forming a diffused airflow spreading widely through the entire discharge port.

In addition, it is easy to switch between the concentrated airflow and the diffused airflow by raising and lowering the airflow control body.

In addition, by rotating the airflow control body so that the opening of the airflow control body faces the area where the sensor is located, it is possible to intensively purify the area where the sensor is located.

In addition, when the airflow control body is lowered, the airflow control body may be positioned between the flow path body and the housing, and the airflow control body may be protected by the flow path body and the housing.

In addition, since the blower of the blowing unit is accommodated in the blower accommodating space formed inside the discharge body, it may be more compact compared to the case where the blower is located outside the discharge body.

In addition, since the motor of the blowing unit is accommodated in the motor housing part formed in the top cover, it may be more compact compared to the case where the motor is located below the top cover.

In addition, the inner body of the flow path body may prevent foreign substances from penetrating between the hollow body of the flow path body and the housing.

### DESCRIPTION OF DRAWINGS

FIG. 1 is a perspective view when an air purifier according to an embodiment of the present disclosure discharges air with a diffused airflow.

FIG. 2 is a cross-sectional view of the air purifier shown in FIG. 1.

FIG. 3 is a perspective view when an air purifier according to an embodiment of the present disclosure discharges air with a concentrated airflow.

FIG. 4 is a cross-sectional view of the air purifier shown in FIG. 3.

FIG. 5 is a perspective view when an air purifier according to an embodiment of the present disclosure discharges air with a concentrated airflow in a direction different from the concentrated airflow shown in FIG. 3.

FIG. 6 is a cross-sectional view of the air purifier shown in FIG. 5.

FIG. 7 is a perspective view of a discharge body and an airflow control body according to an embodiment of the present disclosure.

FIG. 8 is a bottom view of an air purifier according to an embodiment of the present disclosure.

FIG. 9 is a plan view when the air purifier shown in FIG. 1 discharges air.

FIG. 10 is a plan view when the air purifier shown in FIG. 3 discharges air.

FIG. 11 is a plan view of the air purifier when the air purifier shown in FIG. 5 discharges air.

FIG. 12 is a control block diagram of the air purifier according to an embodiment of the present disclosure.

### BEST MODE

Hereinafter, specific embodiments of the present disclosure will be described in detail with drawings.

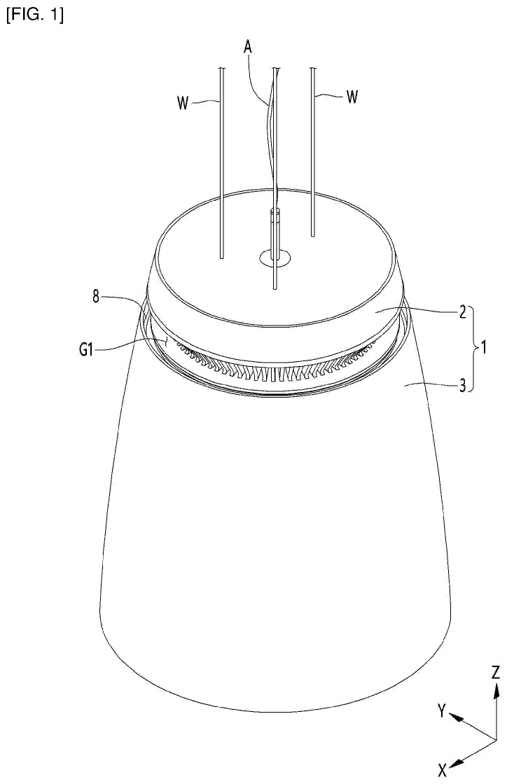

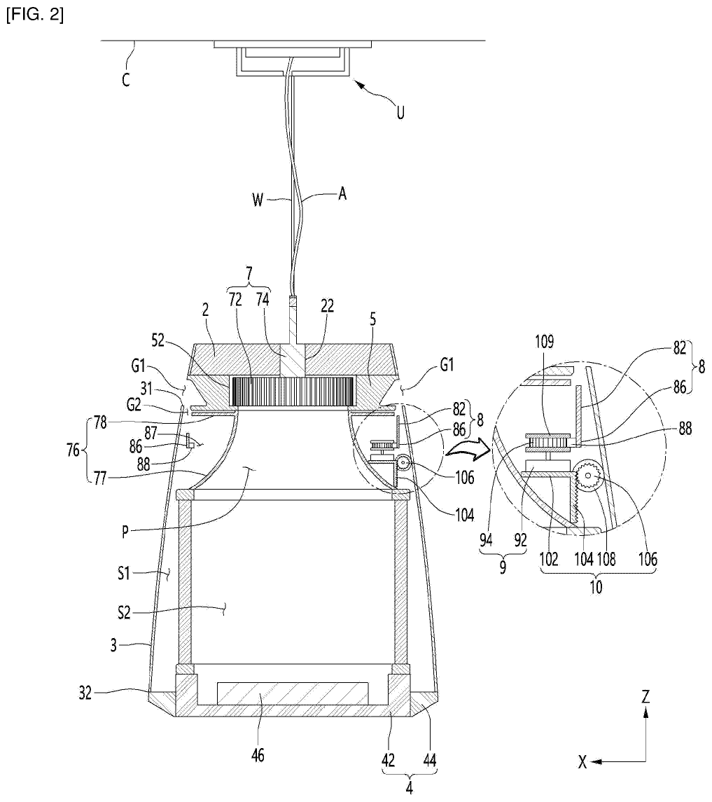

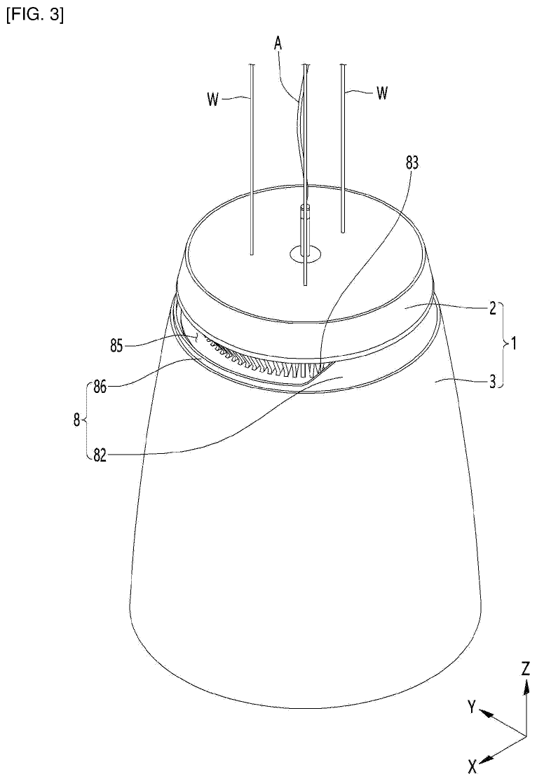

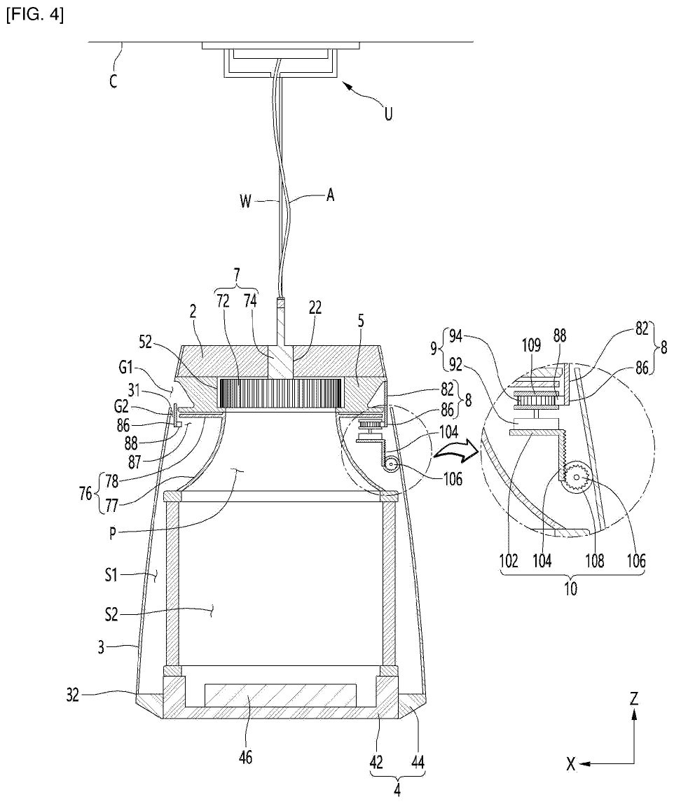

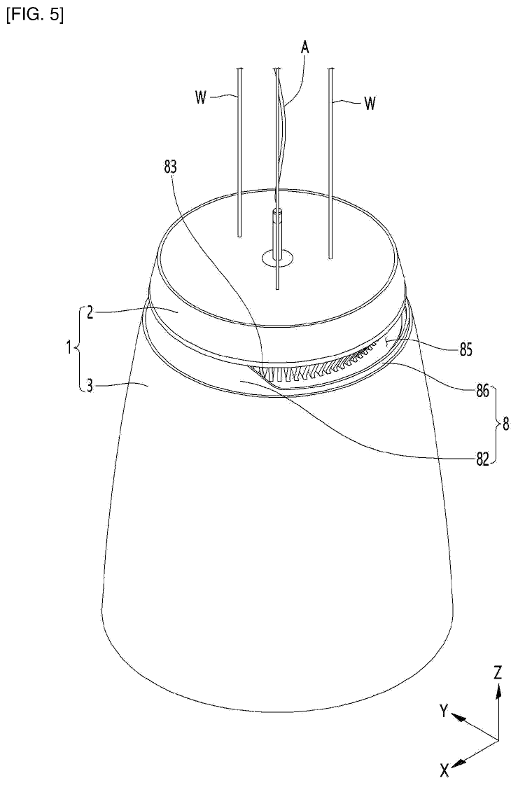

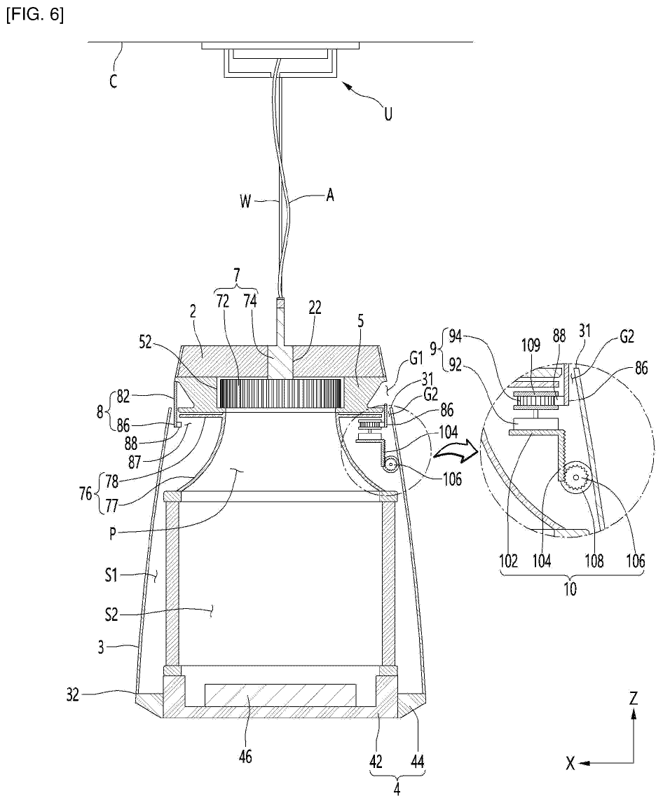

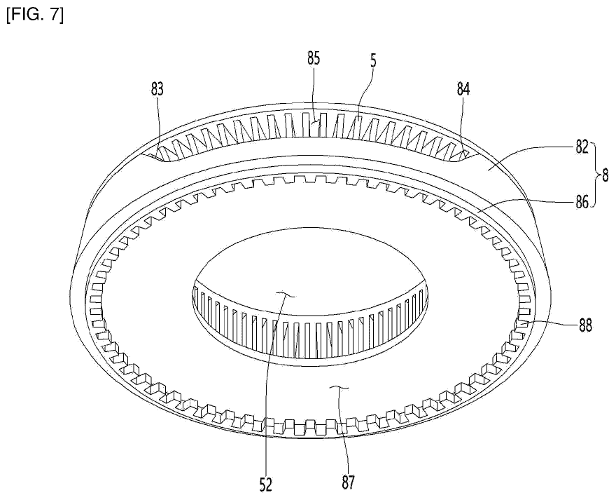

FIG. 1 is a perspective view when an air purifier according to an embodiment of the present disclosure discharges air with a diffused airflow, FIG. 2 is a cross-sectional view of the air purifier shown in FIG. 1, FIG. 3 is a perspective view when an air purifier according to an embodiment of the present disclosure discharges air with a concentrated airflow, FIG. 4 is a cross-sectional view of the air purifier shown in FIG. 3, FIG. 5 is a perspective view when an air purifier according to an embodiment of the present disclosure discharges air with a concentrated airflow in a direction different from the concentrated airflow shown in FIG. 3, FIG. 6 is a cross-sectional view of the air purifier shown in FIG. 5, and FIG. 7 is a perspective view of a discharge body and an airflow control body according to an embodiment of the present disclosure.

The air purifier includes a case 1 forming appearance, a purification unit 6 accommodated inside the case 1, a blowing unit 7 for flowing air, and an airflow control body 8 for controlling a discharge airflow.

The case 1 may be mounted to hang from a ceiling C. The case 1 may be mounted to hang from a hanger unit installed on a ceiling. The hanger unit may include a support body extending downward. The support body may support the case 1 such that the case 1 is spaced apart from the ceiling. An example of the support body may be a wire W extending downward.

The hanger unit may include an electric wire A for supplying power to the motors 74, 92, 108 constituting the air purifier, and the electric wire A may extend downward, like the wire W.

A suction port may be formed in a lower portion of the case 1, and a discharge port may be formed in an upper portion of the case 1.

A space S1 may be formed in the case 1.

The case 1 may be composed of a combination of a plurality of members. The case 1 may include a top cover 2 and a housing 3. The space S1 may be defined as a space surrounded by the housing 3, and the top cover 2 may cover an upper side of the space S1.

At least one of the top cover 2 or the housing 3 may be connected to the wire W, and the case 1 may be maintained in a suspended state through the wire W, as shown in FIGS. 2, 4 and 6.

The top cover 2 may form appearance of the upper surface of the air purifier. The wire W may be connected to the upper surface of the top cover 2.

In the top cover 2, a motor housing part 22 surrounding the outer circumference of the motor 74 to be described later of the blowing unit 7 may be formed. The motor housing part 22 may include an opening into which at least a part of the motor 74 is inserted and accommodated, and the motor housing part 22 may protect the motor 74. The motor housing part 22 may be formed to penetrate through the top cover 2 in a vertical direction Z.

The housing 3 may form appearance of the circumferential surface of the air purifier. The space S1 may be formed inside the housing 3, and the housing 3 may include a tubular body having the space S1 formed therein.

A discharge port G1 may be formed between the top cover 1 and the housing 3. Air purified in the housing 3 may be discharged to the outside of the housing 3 through the discharge port G1. The discharge port G1 may be a variable discharge port that may be partially opened and closed by the airflow control body 8.

The airflow control body 8 may ascend from the lower side of the discharge port G1 to the discharge port G1 or descend from the upper side of the discharge port G1 to the discharge port G1, and may be located at the discharge port G1 when ascending and descending.

When the airflow control body 8 is located at the discharge port G1, air is not discharged through a shielding area where the airflow control body 8 is located of the discharge port G1 and may be discharged through an open area where the airflow control body 8 is not located of the discharge port G1.

The housing 3 may be formed to be elongated in the vertical direction. The housing 3 may include an upper end 31 and a lower end 32.

The upper end 31 of the housing 3 may be spaced apart from the ceiling of the room in the vertical direction Z. The lower end 32 of the housing 3 may be spaced apart from the floor of the room in the vertical direction Z.

In the example of the case 1, the upper end 31 of the housing 3 and the top cover 2 may be spaced apart from each other. The discharge port G1 may be formed between a lower surface of the top cover 1 and the upper end 31 of the housing 3. The discharge port G1 may be a gap formed between the lower surface of the top cover 1 and the upper end 31 of the housing 3.

In another example of the case 1, the top cover 2 and the housing 3 may be connected through a separate connecting body. The connecting body may be disposed to cross the discharge port G1, or a plurality of connecting bodies may be disposed to be spaced apart from each other along a circumferential direction of the discharge port G1. The connecting body may be formed to be transparent or translucent.

In another example of the case 1, the top cover 2 and the housing 3 may be integrally formed, and the upper portion of the housing 3 and the top cover 2 are formed by a plurality of ribs spaced apart from each other in the circumferential direction. In this case, a plurality of the discharge ports G1 partitioned by a plurality of ribs may be formed between the upper portion of the housing 3 and the top cover 2.

The discharge port G1 may be opened in the horizontal directions X and Y. The discharge port G1 may be opened in all horizontal directions including the front-and-rear direction (X) and the left-and-right direction Y.

The air flowing inside the case 1 may be discharged in the horizontal directions X and Y through the discharge port G1.

The cross-sectional shape of the discharge port G1 may be a ring shape. As shown in FIG. 2, when the airflow control body 8 is lowered, the discharge port G1 may be opened in all horizontal directions of 360°. In this case, the air flowing inside the air purifier may be dispersed and discharged in all horizontal directions of 360°.

The case 1 may further include a suction body 4 and a discharge body 5.

The suction body 4 may form appearance of the bottom of the air purifier. The suction body 4 may be disposed below the housing 3. When the blowing unit 7 is driven, the air outside the air purifier may be sucked into the space S1 of the housing 3 after passing through the suction body 4.

In the suction body 4, a suction port through which air from the outside of the case 1 is sucked into the inside of the case 1 may be formed.

The suction body 4 may include an inlet guide 42 for guiding the suction of air. The outer circumference of the inlet guide 42 may be spaced apart from the inner circumference of the lower portion of the housing 3, and a suction passage through which air is sucked into the space S1 is formed between the outer circumference of the inlet guide 42 and the lower portion of the housing 3.

The suction body 4 may be composed of a combination of a plurality of members.

The suction body 4 may include a suction grill 44. In the suction grill 44, a suction port through which air passes may be formed. The suction grill 44 may be disposed to be positioned in the suction passage. The suction grill 44 may be disposed outside the outer circumference of the inlet guide 42 as a whole. The suction grill 44 may be disposed between the outer circumference of the inlet guide 42 and the inner circumference of the lower portion of the housing 3.

The suction grill 44 may include one end in contact with the inlet guide 42 and the other end in contact with the lower portion of the housing 3.

The lower end of the suction grill 44 may be formed obliquely and may be formed to be inclined such that the height gradually increases from one end to the other end.

The air purifier may further include a lighting device. In this case, the air purifier may further include a lighting device 46 disposed on the inlet guide 42.

The lighting device 46 may be disposed to illuminate the lower portion of the air purifier. The lighting device 46 may include a light source such as an incandescent lamp, a fluorescent lamp or an LED assembly. The lighting device 46 may be disposed at the lower portion of the case 1.

The lighting device 46 may be disposed on the inlet guide 42, and, in this case, the inlet guide 42 may include a diffusion plate through which light of the lighting device 46 is diffused.

The discharge body 5 may be disposed below the top cover 2. The discharge body 5 may be disposed to be visible through the discharge port G1. The discharge body 5 may be disposed to be located inside the discharge port G1.

The discharge body 5 may be disposed between the top cover 2 and a flow path body 86 to be described later. A blower accommodation space 52 in which a blower 52 is rotatably accommodated may be formed inside the discharge body 5.

The discharge body 5 may be configured to pass air blown by the blowing unit 7. The discharge body 5 may include a discharge grill disposed outside the blower 72 to be described later of the blowing unit 7. The discharge grill may be located outside the outer circumference of the blower 72 to surround the outer circumference of the blower and to protect the blower 72.

The upper portion of the discharge body 5 may be connected to the lower portion of the top cover 2.

The lower portion of the discharge body 5 may be spaced apart from the inner circumference of the housing 3, and a gap G2 through which the airflow control body 8 may pass may be formed between the lower portion of the discharge body 5 and the inner circumference of the housing 3.

The gap G2 may face the outside of the discharge body 5 in the vertical direction Z.

The purification unit 6 may be accommodated in the space S1. The purification unit 6 may include at least one filter, and an example of such a filter include a high-performance filter such as a HEPA filter, a humidifying filter for absorbing moisture, an electric dust collection filter having a charging unit (or an ionizing unit) or a renewable zeolite filter.

If the purification unit 6 is a configuration that may purify air, it may be applied to all without being limited to its operating method.

The purification unit 6 may have a space S2 formed therein and a hollow cylindrical shape opened in the vertical direction Z.

The lower portion of the purification unit 6 may be placed on the suction body 4, particularly, the upper surface of the inlet guide 42. The inlet guide 42 may be connected to the lower portion of the purification unit 6.

The upper portion of the purification unit 6 may be connected to the lower portion of the flow path body 76. The space S2 formed inside the purification unit 6 may be located below the passage P of the flow path body 76 and may communicate with the passage P of the flow path body 76.

Air which has passed through the suction body 4, in particularly, the suction grill 44 may pass through the purification unit 6 while flowing from the outside of the outer circumference of the purification unit 6 toward the space S2 of the purification unit 6. Air flowing to the space S2 after passing through the purification unit 6 may flow to the passage P located above it.

The blowing unit 7 may suck air into the suction body 4, pass it through the purification unit 6 and the flow path body 76, and then blow it to the discharge body 5. The blowing unit 7 may include the blower 72 and a motor 74 for rotating the blower 72.

The blower 72 may be rotatably accommodated in a blower accommodation space 52. The blower 72 may be rotated about a vertical central axis. The blower 72 may be a centrifugal type blower that sucks air from the lower side and blows it in a centrifugal direction.

The motor 74 may be installed on the top cover 2 and may be connected to the blower 72. The motor 74 may be fixed to the motor housing part 22 formed in the center of the top cover 2, and a rotation shaft for rotating the blower 72 extends downward to be connected to the vertical central shaft of the blower 72.

The air purifier may further include a flow path body 76 that is accommodated in the space S1 and guides the air that has passed through the suction body 4 to be sucked into the blowing unit 7.

The flow path body 76 may be disposed below the discharge body 5. An upper portion of the flow path body 76 may be a lower portion of the discharge body 5.

The flow path body 76 may include a hollow body 77. The passage P through which air passes may be formed in the hollow body 77. The hollow body 77 may be disposed on the purification unit 6. The hollow body 77 may have a shape gradually extending downward.

The passage P may be formed such that the cross-sectional area thereof gradually decreases upward. The hollow body 77 may function as an orifice to guide the air sucked into the blowing unit 7.

The lower portion of the hollow body 77 may be connected to the upper portion of the purification unit 6.

The flow path body 76 may include an inner body 78. The inner body 78 may be disposed on the hollow body 77. The inner body 78 may extend from the upper end of the hollow body 77 in the horizontal direction. The inner body 78 may extend to protrude from the upper end of the hollow body 77 in the horizontal direction. The outer circumference of the inner body 78 may face the inner circumference of the housing 3.

The inner body 78 may block between the upper portion of the hollow body 77 and the upper portion of the housing 3. The inner body 78 may be spaced apart from the top cover 2 in the vertical direction Z. The flow path body 76 may be connected to the lower portion of the discharge body 5. The inner body 78 may be connected to a lower portion of the discharge body 5, and the inner body 78 may be connected to the top cover 2 by the discharge body 5.

The flow path body 76 may be disposed to penetrate the airflow control body 8, particularly, a lower body 86 to be described later. The lower body 86 may be located outside the outer circumference of the flow path body 76, particularly, the hollow body 77.

The airflow control body 8 may be arranged to control the airflow of the air discharged from the case 1 to the outside.

The size of the airflow control body 8 may be smaller than the open area of the discharge port G1 opened between the top cover 2 and the housing 3.

In the airflow control body 8, an opening 85 opened in the horizontal direction may be formed.

In the airflow control body 8, a hollow part 87 opened in the vertical direction Z may be formed.

The airflow control body 8 may include an air guide 82. One end 83 and the other end 84 of the air guide 82 may be spaced apart in the circumferential direction.

The cross-sectional shape of the air guide 82 may be an arc shape. An opening 85 may be formed between one end 83 and the other end 84 of the air guide 82.

When the air guide 82 rises, the air guide 82 may be located outside the outer circumference of the discharge body 5.

The airflow control body 8, particularly, the air guide 82 may be formed to be transparent or translucent, and, when the airflow control body 8 rises, the discharge body 5 is visible through the airflow control body 8 and is protected by the airflow control body 8.

When the air guide 82 rises, the inner circumferential surface thereof may face the discharge body 5 in the horizontal direction, and the air which has passed through the discharge body 5 will flow along the inner circumferential surface of the air guide 82.

When the air guide 82 is lowered, the air guide 82 may be located between the flow path body 76 and the housing 3. That is, when the air guide 82 is lowered, the air guide 82 may be protected by the housing 3.

When the air guide 82 is lowered, the upper end of the air guide 82 may be located below the discharge port G1. When the air guide 82 is lowered, the outer circumferential surface of the air guide 82 may face the inner circumferential surface of the housing 3. When the air guide 82 is lowered, the inner circumferential surface of the air guide 82 may be lowered in the horizontal direction relative to the outer circumferential surface of the flow path body 76.

The airflow control body 8 may further include a lower body 86. The lower body 86 may be formed below the air guide 82. A hollow part 87 may be formed to open in the vertical direction Z in the center of the lower body 86.

The lower body 86 may have a ring shape like the discharge port G1. The hollow part 87 may be formed by the inner circumference of the lower body 86.

The air purifier may include a rotating mechanism 9 for rotating the airflow control body 8.

The rotating mechanism 9 may include a rotating motor 92 and a driving gear 94 rotated by the rotating motor 92.

The airflow control body 8 may be provided with a driven gear 88 engaged with the driving gear 94.

The driven gear 88 may be formed below the airflow control body 8. The rotating mechanism 9 may rotate the lower body 86. The driven gear 88 may be formed on the lower body 86.

The driven gear 88 may be formed along the inner circumference or outer circumference of the lower body 86. The driven gear 88 may be formed in a ring shape as a whole. The driven gear 88 may be formed on the inner circumference of the lower body 86.

The rotating mechanism 9 may be accommodated between the outer circumferential surface of the hollow body 77 of the flow path body 76 and the inner circumferential surface of the housing 3.

The air purifier may include a lifting mechanism 10 for raising and lowering the airflow control body 8.

The lifting mechanism 10 may raise the airflow control body 8 to the discharge port G1 or lower the airflow control body into the housing 3.

The lifting mechanism 10 may raise and lower the rotating mechanism 9, and, when the rotating mechanism 9 is raised or lowered by the lifting mechanism 10, the airflow control body 8 may be raised or lowered along with the rotating mechanism 9.

An example of the lifting mechanism 10 may include a carrier 102 equipped with the rotating mechanism 9, a rack 104 provided on the carrier 102, a pinion 106 engaged with the rack 104, and a lifting motor 108 for rotating the pinion 106.

The lifting motor 108 may be positioned to be fixed to the housing 3 or the flow path body 76, and may rotate the pinion 106.

The lifting mechanism 10 may be accommodated between the outer circumferential surface of the hollow body 77 of the flow path body 76 and the inner circumferential surface of the housing 3.

The lifting motor 108 may be mounted directly on the housing 3 or the flow path body 76 or may be mounted on the housing 3 or the flow path body 76 by a separate motor mounter.

The air purifier may further include a lifting guide for guiding the raising and lowering of the rotating mechanism 9, the lifting guide may be formed to be elongated in the vertical direction Z inside the housing 3. The lifting guide may be formed to directly guide the carrier 102 in the vertical direction or to guide the rack 104 in the vertical direction.

At least one of the rotating mechanism 9 or the lifting mechanism 10 may be provided with a lifting body 109 for raising or lowering the airflow control body 8 while the rotating mechanism 9 is raised or lowered.

The lifting body 109 may protrude from the driving gear 94 or the carrier 102 toward the airflow control body 8, and the lifting body 109 and the airflow control body 8 may be constrained to each other in the vertical direction. When the lifting body 109 rises, the airflow control body 8 is lifted upward by the lifting body 109, and, when the lifting body 109 is lowered, the airflow control body 8 is lifted downward by the lifting body 109.

An example of the lifting body 109 may include an upper lifting body formed on the upper portion of the driving gear 94 and mounted on the upper surface of the driven gear 88, and a lower lifting body formed on the lower portion of the driving gear 94 and mounted on the lower surface of the driven gear 88.

In this case, when the lifting body 109 is lowered together with the driving gear 94, the upper lifting body may press the driven gear 88 in a downward direction, and the driven gear 88 and the airflow control body 8 may be lowered by the upper lifting body in the downward direction.

On the other hand, when the lifting body 109 rises together with the driving gear 94, the lower lifting body can lift the driven gear 88 upward, and the driven gear 88 and the airflow control body 8 may be raised by the lower lifting body in an upward direction.

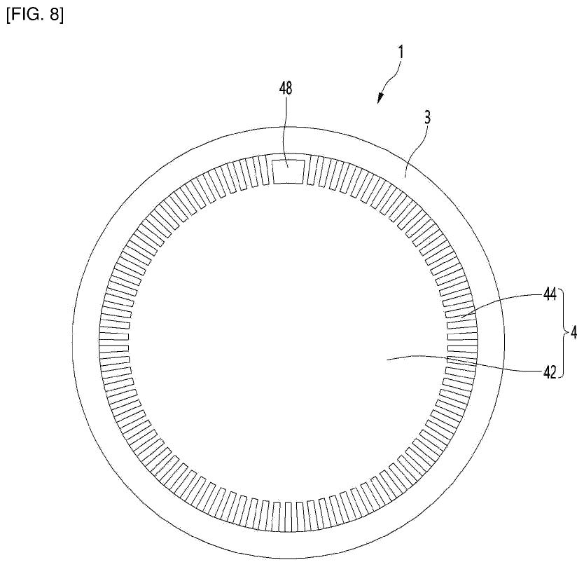

FIG. 8 is a bottom view of an air purifier according to an embodiment of the present disclosure.

The air purifier may further include a thermal sensor 48 disposed on the lower portion of the housing 3 or the suction body 4. The thermal sensor 48 may be installed on one side of the suction body 4, particularly, the suction grill 44.

The suction grill 44 may have a ring shape, and the suction grill 44 may include a grill area in which a grill is formed, and a non-grill area in which a grill is not formed. The grill area may be a major arc-shaped area as a whole.

The thermal sensor 48 may be disposed in the non-grill area. The thermal sensor 48 may be a non-contact temperature sensor capable of sensing the temperature while not in contact with a human body or a cooker, and may be, for example, an infrared sensor.

The thermal sensor 48 may detect the temperature of an object located below or around the housing 3, and may transmit the sensed result to the controller 120.

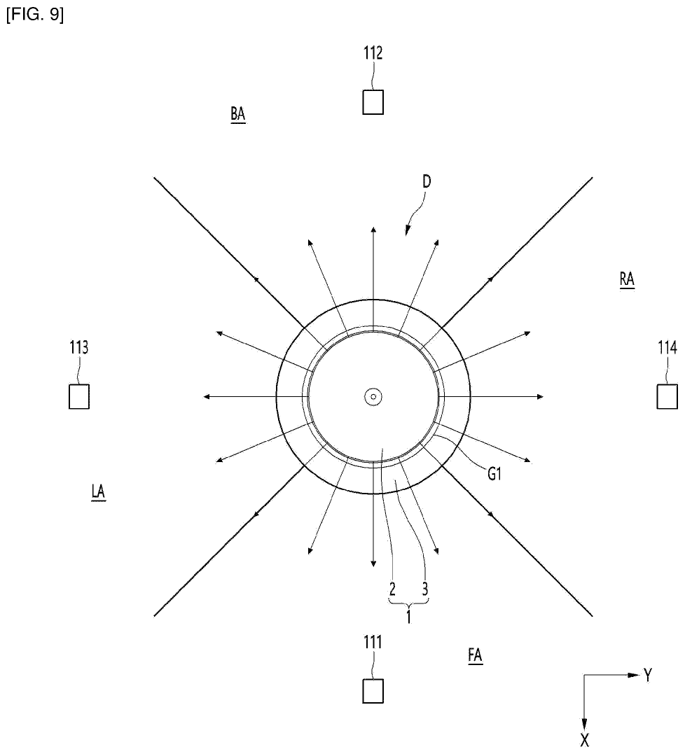

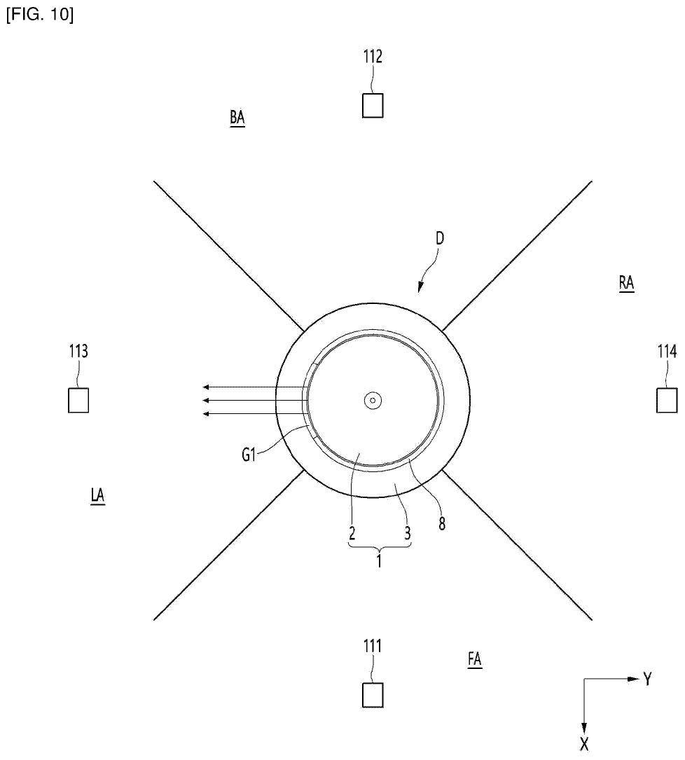

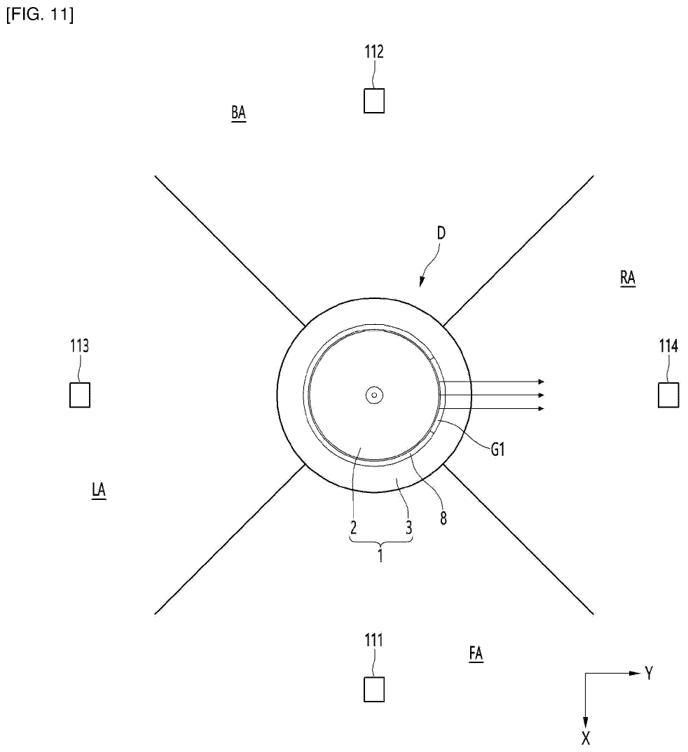

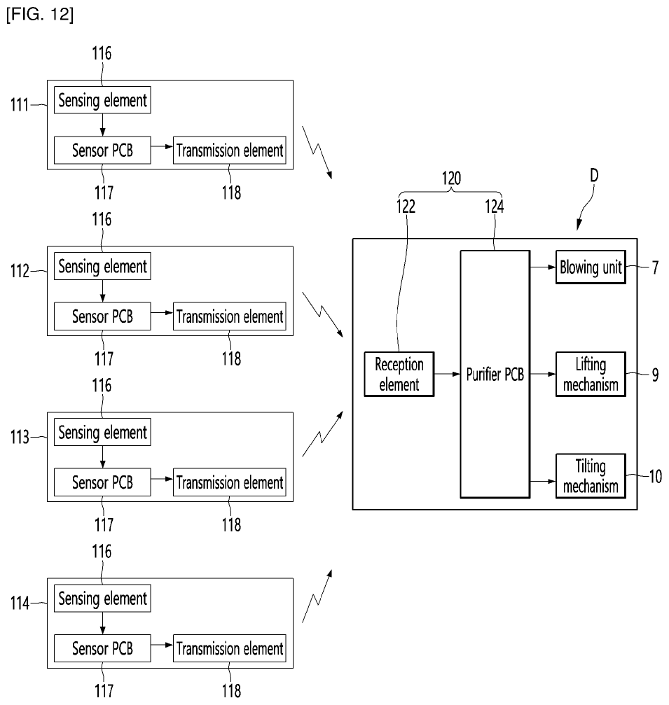

FIG. 9 is a plan view when the air purifier shown in FIG. 1 discharges air, FIG. 10 is a plan view when the air purifier shown in FIG. 3 discharges air, and FIG. 11 is a plan view of the air purifier when the air purifier shown in FIG. 5 discharges air, and FIG. 12 is a control block diagram of the air purifier according to an embodiment of the present disclosure.

The air purifier of this embodiment may include at least one sensor for sensing an indoor pollution level.

The at least one sensor may be spaced apart from the housing 3, and may sense an indoor pollution level from the outside of the housing 3.

At least one sensor is preferably provided at a position where the air purified in the air purifier may be reached. The at least one sensor may be disposed at a location spaced apart from the housing 3 by a predetermined distance or more.

The air purifier may include the case 1, a combination (hereinafter, referred to as a clean module D) of the components arranged in the case 1 (e.g., the purification unit 6, the blowing unit 7, the rotating mechanism 9 and the lifting mechanism 10, etc.) and at least one sensor spaced apart from the clean module D to sense the pollution level.

At least one sensor may be communicatively connected to a controller 120.

At least one sensor may include a sensor element 116 for sensing foreign substances, a sensor PCB 117 for processing the sensing value of the sensing element 116, and a transmission element 118 connected to the sensor PCB 117 to transmit a signal generated by the sensor PCB 117 to the outside.

The sensing element 116 may include a dust sensor for sensing the concentration of foreign substances in the air. An example of the dust sensor may be an optical sensor and the dust sensor may include a housing formed with an opening through which external air may be introduced, a light source, such as an LED or laser, capable of emitting light to the air introduced into the housing, a light reception element, such as a photodiode or a phototransistor, for detecting the amount of light scattered by dust such as fine dust. Such a dust sensor may output the concentration of dust (i.e., the concentration of the foreign substances) detected by the light reception element as the magnitude of a concentration sensing value (e.g., voltage).

The sensor PCB 117 may process a sensing value output from the sensing element 116, and transmit a corresponding signal to the controller 120, particularly, a reception element 122 to be described later.

The controller 120 may include a reception element 122 for receiving a signal transmitted by the transmission element 118, and a purifier PCB 124 connected to the reception element 122 to control the blowing unit 7, the rotating mechanism 9 and the lifting mechanism 10 according to the signal received by the reception element 122.

The reception element 122 may be connected to the transmission element 118 through wired or wireless communication, for example, by a communication method such as GSM (Global System for Mobile communication), CDMA (Code Division Multi Access), LTE (Long Term Evolution), 5G, WLAN (Wireless LAN), Wi-Fi (Wireless-Fidelity), Bluetooth (Bluetooth™), RFID (Radio Frequency Identification), Infrared Data Association (IrDA), ZigBee, NFC (Near Field Communication), etc.

The air purifier may include a plurality of sensors 111, 112, 113 and 114. Each of the plurality of sensors 111, 112, 113 and 114 may be communicatively connected to the controller 120.

The plurality of sensors 111, 112, 113 and 114 may be disposed to be spaced apart from each other in a room where the clean module D is disposed, and may be disposed to be spaced apart from the housing 3 outside the housing 3.

The room where the air purifier is placed may be divided into four areas, such as front, rear, left, and right, based on the center of the air purifier, and the sensor may be located in each of these four areas (FA, BA, LA, RA).

An example of the plurality of sensors 111, 112, 113 and 114 may include a front sensor 111 disposed in the front space FA, a rear sensor 112 disposed in the rear space BA, a left sensor 113 accommodated in the left space LA and a right sensor 114 accommodated in the right space RA.

The air purifier may further include the controller 120. The controller 120 may control the blowing unit 7, the rotating mechanism 9 and the lifting mechanism 10.

The controller 120 may control the motor 74 of the blowing unit 7 when controlling the blowing unit 7.

The controller 120 may control the rotating motor 92 of the rotating mechanism 9 when controlling the rotating mechanism 9.

The controller 120 may control the lifting motor 108 of the lifting mechanism 10 when controlling the lifting mechanism 10.

The controller 120 may control at least one of the rotating mechanism 9 or the lifting mechanism 10 according to the pollution level sensed by the sensors 111, 112, 113, and 114.

The controller 120 may control the air purifier in a concentrated discharge mode when the pollution level sensed by the sensors 111, 112, 113, and 114 is in a set range.

The set range may be a range of the pollution level in which it can be determined that the vicinity of the sensor is contaminated. The set range may include a case in which the pollution level is equal to or greater than a set pollution level. When the set range is greater than or equal to the set pollution level, a clean range may be a range less than the set pollution level.

In the concentrated discharge mode, the controller 120 may enable the opening 85 to face an area in which the sensor is located and control the rotating mechanism 9 and the lifting mechanism 10 for this.

In the concentrated discharge mode, the controller 120 may control the lifting mechanism 10 in an ascending mode, and may control the rotating mechanism 9 so that the opening 85 faces an area corresponding to the sensor.

The controller 120 may control the rotating mechanism 9 and the lifting mechanism 10 in a plurality of modes.

The plurality of modes may include a diffused discharge mode in which the lifting mechanism 10 is in a descending mode, In addition, the plurality of modes may include a concentrated discharge mode in which the lifting mechanism 10 is in an ascending mode.

In the diffused discharge mode, the rotating mechanism 9 may be stationary, and the lifting mechanism 10 may operate in the descending mode. In the diffused discharge mode, the airflow control body 8 may not be located in the discharge port G1, may be located inside the housing 3, and face the inner circumference of the housing 3.

In this case, the air purified in the purification unit 6 may be evenly spread through the entire discharge port G1 of the air purifier, and, in the air purifier, as shown in FIG. 9, a diffused airflow discharged in a direction of 360° may be discharged.

For example, the controller 120 may control the lifting mechanism 10 in the descending mode if the pollution level sensed by the sensor is in the clean range.

As another example, when the air purifier includes the plurality of sensors 111, 112, 113 and 114 and the pollution level sensed by all the sensors 111, 112, 113, and 114 is in the clean range or set range, the controller 120 may control the lifting mechanism 10 in the descending mode. If the pollution levels of all areas of the room are similar, the lifting mechanism 10 may be controlled in the descending mode so that all areas of the room are cleaned evenly without discharging air in a specific direction.

Meanwhile, in the concentrated discharge mode, the rotating mechanism 9 may rotate the airflow control body 8 such that the opening faces any one of the front area FA, the rear area BA, the left area LA, and the right area RA.

The concentrated discharge mode may include a front concentrated mode, and, in the front concentrated mode, the airflow control body 8 may rise by the lifting mechanism 10, and the opening 85 may face the front area FA in which the front sensor 111 is located.

If the pollution level sensed by the front sensor 111 is in the set range and the pollution level sensed by the other sensors 112, 113, and 114 is in the clean range other than the set range, the front concentration mode may be implemented.

The concentrated discharge mode may include a rear concentrated mode, and, in the rear concentrated mode, the airflow control body 8 may rise by the lifting mechanism 10, and the opening 85 may face the rear area BA in which the rear sensor 112 is located.

If the pollution level sensed by the rear sensor 112 is in the set range and the pollution level sensed by the other sensors 111, 113, and 114 is in the clean range other than the set range, the rear concentration mode may be implemented.

The concentrated discharge mode may include a left concentrated mode, and, in the left concentrated mode, the airflow control body 8 may rise by the lifting mechanism 10, and the opening 85 may face the left area LA in which the left sensor 113 is located, as shown in FIG. 10.

If the pollution level sensed by the left sensor 113 is in the set range and the pollution level sensed by the other sensors 111, 113, and 114 is in the clean range other than the set range, the left concentration mode may be implemented.

The concentrated discharge mode may include a right concentrated mode, and, in the right concentrated mode, the airflow control body 8 may rise by the lifting mechanism 10, and the opening 85 may face the right area RA in which the right sensor 114 is located, as shown in FIG. 11.

If the pollution level sensed by the right sensor 114 is in the set range and the pollution level sensed by the other sensors 111, 112, and 113 is in the clean range other than the set range, the right concentration mode may be implemented.

Meanwhile, the present disclosure is not limited to the above embodiment, and the air purifier may be controlled using the temperature factor sensed by the thermal sensor 48 prior to the pollution factor sensed by the sensors 111, 112, 113, and 114.

For example, the controller 120 may detect a human body if the temperature sensed by the thermal sensor 48 is in the temperature range of the human body (e.g., 35° C. to 40° C.), and detect that the cooker is currently operating when the temperature detected by the thermal sensor 48 exceeds the temperature (e.g., 50° C.) when the cooker (e.g., a cooktop or gas stove) is operating.

When a human body is detected by the thermal sensor 48 or that the cooker is currently operating, the controller 120 may perform the diffused discharge mode without performing the concentrated discharge mode according to the sensing of the sensors 111, 112, 113, and 114 as described above.

In this case, the air purified in the purification unit 6 may be discharged while spreading widely through the entire discharge port G1 of the air purifier, and purify the vicinity of the housing 3 evenly.

The above description is merely illustrative of the technical idea of the present disclosure, and various modifications and variations are possible without departing from the essential characteristics of the present disclosure by those of ordinary skill in the art to which the present disclosure pertains.

Accordingly, the embodiments disclosed in the present disclosure are not intended to limit the technical spirit of the present disclosure, but are intended to explain the technical spirit of the present disclosure, and the scope of the technical spirit of the present disclosure is not limited by these embodiments.

The scope of the present disclosure should be interpreted by the following claims, and all technical ideas within the scope equivalent thereto should be construed as being included in the scope of the present disclosure.

1. An air purifier comprising:
a case having a suction port formed in a lower portion thereof and a discharge port opened in an upper portion thereof in a horizontal direction;
a purification unit accommodated in the case;
a blowing unit configured to suck air into the suction port, to passes air through the purification unit and to blow air to the discharge port;
an airflow control body having an opening having a smaller size than the discharge port and opened in the horizontal direction;
a lifting mechanism for raising or lowering the airflow control body; and
a rotating mechanism configured to rotate the airflow control body.

2. The air purifier of claim 1,
wherein the case comprises:
a top cover; and
a housing having an upper end spaced apart from the top cover and having a space formed therein, and
wherein the discharge port is formed between the upper end of the housing and the top cover.

3. The air purifier of claim 1, further comprising:
a sensor configured to sense an indoor pollution level; and
a controller configured to control the rotating mechanism in a concentrated discharge mode in which the opening faces an area in which the sensor is located, when a pollution level sensed by the sensor is in a set range.

4. An air purifier comprising:
a top cover;
a housing having an upper end spaced apart from the top cover and a space formed therein;
a purification unit accommodated in the space;
a suction body disposed below the housing and having a suction port formed therein;
a discharge body disposed below the top cover;
a flow path body disposed below the discharge body;
a blowing unit configured to suck air into the suction body to pass air through the purification unit and the flow path body and to blow air to the discharge body;
an airflow control body having a smaller size than an open area of a discharge port opened between the top cover and the housing; and
a rotating mechanism configured to rotate the airflow control body.

5. The air purifier of claim 4, wherein the airflow control body has an opening opened in a horizontal direction.

6. The air purifier of claim 5, further comprising:
a sensor configured to sense an indoor pollution level; and
a controller configured to control the rotating mechanism in a concentrated discharge mode in which the opening faces an area in which the sensor is located, when a pollution level sensed by the sensor is in a set range.

7. The air purifier of claim 6,
wherein a plurality of sensors is provided to be spaced apart from each other,
wherein each of the plurality of sensors is spaced apart from the housing outside the housing.

8. The air purifier of claim 4,
wherein a cross-sectional shape of the discharge port is a ring shape, and
wherein the airflow control body includes an air guide having one end and the other end spaced apart in a circumferential direction and a cross-sectional shape thereof is an arc shape.

9. The air purifier of claim 8, wherein the cross-sectional shape of the air guide is a major arc shape.

10. The air purifier of claim 8, wherein the airflow control body further comprises a lower body connected to a lower portion of the air guide and rotated by the rotating mechanism.

11. The air purifier of claim 10, wherein a cross-sectional shape of the lower body is a ring shape.

12. The air purifier of claim 10,
wherein the lower body has a hollow part opened in a vertical direction, and
wherein the flow path body penetrates the hollow part.

13. The air purifier of claim 4, further comprising a hanger unit having a support body connected to at least one of the top cover or the housing and installed on a ceiling.

14. The air purifier of claim 4,
wherein a blower accommodation space is formed in the discharge body, and
wherein the blowing unit comprises a blower formed in the blower accommodation space and a motor installed on the top cover and connected to the blower.

15. The air purifier of claim 14, wherein a motor housing part surrounding an outer circumference of the motor is formed in the top cover.

16. The air purifier of claim 4, wherein the flow path body comprises:
a hollow body disposed on the purification unit and having formed therein a passage through which air passes; and
an inner body extending from an upper portion of the hollow body toward an upper portion of the housing.

17. The air purifier of claim 4,
wherein the rotating mechanism comprises a rotating motor and a driving gear rotated by the rotating motor, and
wherein a driven gear engaged with the driving gear is provided below the airflow control body.

18. The air purifier of claim 17, wherein the driven gear is formed along an inner circumference of the airflow control body.

19. The air purifier of claim 4, further comprising a lifting mechanism configured to raise the airflow control body to the discharge port or to lower the airflow control body into the housing.

20. The air purifier of claim 19, wherein the lifting mechanism comprises:
a carrier in which the rotating mechanism is mounted;
a rack provided in the carrier;
a pinion engaged with the rack; and
a lifting motor disposed on the housing or the flow path body to rotate the pinion.
